(19) United States
(12) Patent Application Publication
(10) Pub. No.: US 2005/0207103 A1
(43) Pub. Date: Sep. 22, 2005

(54) Apparatus and method for increasing bulk shipping density of partially assembled computer chassis

(75) Inventor: Christopher D. Russo, San Diego, CA (US)

Correspondence Address: FITCH EVEN TABIN & FLANNERY, 120 SOUTH LASALLE SUITE 1600, CHICAGO, IL, 60603, US

(73) Assignees: Sony Corporation, Shinagawa-Ku (JP); Sony Electronics Inc., Park Ridge, NJ (US)

(21) Appl. No.: 10/805,155

(22) Filed: Mar. 19, 2004

(51) Int. Cl. G06F 1/16

(52) U.S. Cl. 361/683

(57) ABSTRACT

A method and apparatus are described for increasing the shipping density of a pallet layout. A method includes forming a first and second computer chassis into a complementary shape wherein the complementary shape includes an empty volume and a non-empty volume. The first and second computer chassis are joined so that the empty volume of the first computer chassis receives at least a portion of the non-empty volume of the second computer chassis. By arranging the joined first and second computer chassis in a single compartment of a pallet layout, the shipping density of a pallet layout may advantageously be increased.

### BACKGROUND OF THE INVENTION

1. Field of the Invention

The present invention relates generally to the manufacture of desktop computers, more specifically, to shipping partially assembled computer chassis from a fabrication plant to a manufacturing center for final assembly.

2. Description of Related Art

Desktop personal computers (PCs) are typically partially assembled by a fabrication plant. The partially assembled computer chassis are called “bare bones” computer chassis. A “bare bones” computer chassis generally includes a metal frame and a number of pre-assembled components. The “bare bones” computer chassis are typically shipped on pallets via container from the fabrication plant to a manufacturing center for final assembly. Each pallet contains a quantity of the partially assembled computer chassis that may be conveniently handled, for example, by a pallet truck or a forklift.

### SUMMARY OF THE INVENTION

In one aspect of the present invention, a method includes steps of:
(a) forming a first and second computer chassis into a complementary shape wherein the complementary shape includes an empty volume and a non-empty volume; and
(b) joining the first and second computer chassis so that the empty volume of the first computer chassis receives at least a portion of the non-empty volume of the second computer chassis.

In another aspect of the present invention, an apparatus includes:
a first computer chassis; and
a second computer chassis joined to the first computer chassis. The first computer chassis and the second computer chassis are formed into a complementary shape that includes an empty volume and a non-empty volume. The empty volume of the first computer chassis receives at least a portion of the non-empty volume of the second computer chassis.

### BRIEF DESCRIPTION OF THE DRAWINGS

A preferred embodiment of the present invention is illustrated by way of example and not limitation in the accompanying figures, in which like references indicate similar elements throughout the several views of the drawings, and in which:

FIG. 1 illustrates a perspective view of a typical pallet layout of partially assembled computer chassis according to the prior art;

FIGS. 2A and 2B illustrate front and perspective views respectively of an embodiment of the present invention in which computer chassis are nested in pairs;

FIG. 2C illustrates a perspective view of a computer chassis having a complementary shape for the nested arrangement of FIGS. 2A and 2B;

FIG. 2D illustrates a perspective view of an alternative embodiment of the present invention in which multiple pairs of computer chassis are nested in a single chassis compartment;

FIGS. 3A and 3B illustrate top and perspective views respectively of an embodiment of the present invention in which computer chassis are interlocked in pairs;

FIG. 3C illustrates a single computer chassis having a complementary shape for the arrangement of FIGS. 3A and 3B;

FIG. 3D illustrates a top view of an alternative embodiment of the present invention in which multiple pairs of computer chassis may be interlocked in a single chassis compartment;

FIG. 4A illustrates a cross-sectional view of an alternative embodiment of the present invention in which a pair of computer chassis may be stacked in a single chassis compartment;

FIG. 4B illustrates an exploded view of the computer chassis arrangement of FIG. A;

FIG. 4C illustrates a cross-sectional view of an interlocked projection and channel for the arrangement of FIGS. 4A and 4B; and

FIG. 5 illustrates a flow chart of a method of increasing shipping density according to an embodiment of the present invention.

The elements shown in the figures are illustrated for simplicity and clarity and have not necessarily been drawn to scale. For example, the dimensions of some elements in the figures may be exaggerated relative to other elements to point out distinctive features in the illustrated embodiments of the present invention described below.

### DESCRIPTION OF THE ILLUSTRATED EMBODIMENTS

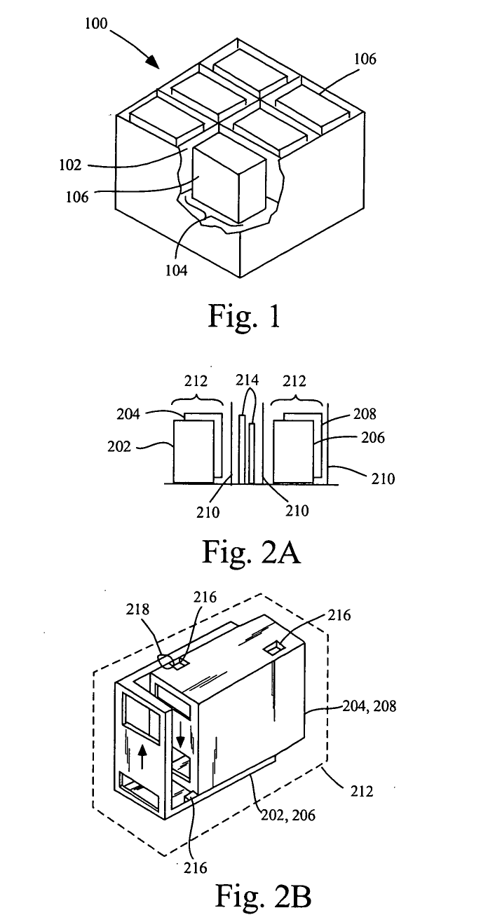

FIG. 1 illustrates a perspective view of a typical pallet layout 100 of partially assembled computer chassis according to the prior art. Shown in FIG. 1 are D-container spacers 102, chassis compartments 104, and partially assembled or “bare bones” computer chassis 106.

The D-container spacers 102 define the sides of each of the rectangular chassis compartments 104 to protect the computer chassis 106 from colliding with one another and to prevent the load from shifting on the pallet. The D-container spacers 102 are typically made of a material such as corrugated cardboard or plastic. The chassis compartments 104 separate the computer chassis 106 from one another to avoid damage to the computer chassis 106 during transportation from the fabrication plant to the manufacturing center. The pallet layout 100 may have several vertical layers of chassis compartments 104 separated by the D-container spacers 102. In the arrangement of FIG. 1, each of the rectangular chassis compartments 104 contains a single computer chassis 106.

A disadvantage of the arrangement illustrated in FIG. 1 is that the low weight of a computer chassis 106 compared to the volume of a chassis compartment 104 results in a low shipping density. Because shipping cost depends on the volume of the container in which the pallets are shipped, a pallet layout that has a low shipping density results in higher shipping costs relative to a pallet layout that has a higher shipping density. When an OEM (original equipment manufacturer) orders partially assembled computer chassis from a manufacturer, the shipping cost is typically incorporated into the cost of the finished product sold by the OEM. The shipping cost of the computer chassis may therefore become a critical factor in the price competitiveness of the OEM's product.

In accordance with various embodiments of the present invention, a higher shipping density and a corresponding lower shipping cost may be realized by modifying the computer chassis 106 to incorporate the nesting, interlocking and stacking features described below.

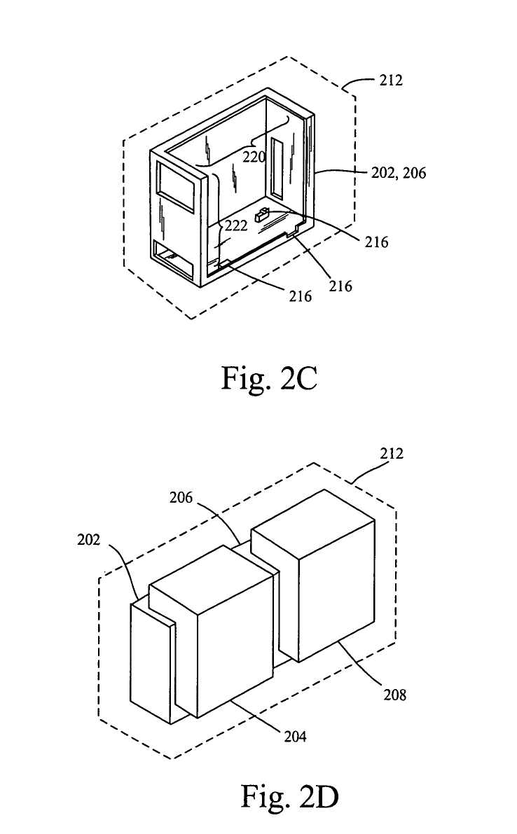

FIGS. 2A and 2B illustrate front and perspective views respectively of a nested pair of computer chassis according to an embodiment of the present invention. Shown in FIGS. 2A and 2B are partially assembled computer chassis 202, 204, 206 and 208, spacers 210, chassis compartments 212, cosmetic panels 214, stamped metal features 216, and a fastener 218.

In the arrangement of FIGS. 2A and 2B, the computer chassis 202, 204, 206 and 208 are formed into an identical complementary shape. In the context of the present invention, a complementary shape is any shape that allows one computer chassis 202 to be joined with another computer chassis 204 so that the rectangular volume of the joined computer chassis is less than twice the rectangular volume of a single computer chassis. The rectangular volume is the minimum volume of a rectangular prism that is sufficient to fully enclose either the joined computer chassis or the single computer chassis.

The computer chassis 202, 204, 206 and 208 may be made of, for example, stamped cold-rolled steel, however, other materials may be used to make the computer chassis 202, 204, 206 and 208 to practice various embodiments of the present invention within the scope of the appended claims.

In one embodiment, the cosmetic panels 214 are shipped with the computer chassis 202, 204, 206 and 208 between the spacers 210. The cosmetic panels are typically used to enclose the fully assembled computer chassis. The cosmetic panels may be made of, for example, molded plastic according to well-known techniques for fastening to the sides, top and front of the fully assembled computer chassis. The cosmetic panels 214 are typically lined with sheet metal for electromagnetic shielding. The cosmetic panels 214 may be wrapped in a suitable material to protect against scratching. In other embodiments, the cosmetic panels 214 are shipped separately from the computer chassis 202, 204, 206 and 208 and are not included in the same pallet layout.

FIG. 2C illustrates a perspective view of a single computer chassis having a complementary shape for the arrangement of FIGS. 2A and 2B. Shown in FIG. 2C is one of the identical computer chassis 202 and 206, a chassis compartment 212, stamped metal features 216, an empty portion 220, and a non-empty portion 222.

In the nested arrangement of FIGS. 2A and 2B, the identical computer chassis 202 and 204 are joined by inserting the non-empty portion 222 of the computer chassis 204 into the empty portion 220 of the computer chassis 202. The empty portion 220 may be, for example, a region above the slots of a motherboard. The actual shape of the non-empty portion 222 may be selected according to well-known techniques of mechanical design to accommodate a number of pre-assembled parts (not shown) that may be assembled on the computer chassis 202 and 204 before the partially assembled computer chassis 202 and 204 are shipped to a manufacturing center for final assembly. For example, an OEM may order partially assembled computer chassis that include standard, inexpensive components such as a floppy disk drive and cable assemblies. The OEM then configures the partially assembled computer chassis with selected high-end components such as CD-ROM drives, hard drives, and so on.

The complementary-shaped computer chassis 202 and 204 in FIG. 2B may be fastened together where they overlap in the empty portion 220 in FIG. 2C by one or more fasteners 218. Each of the fasteners 218 may be, for example, a tie wrap. The fasteners 218 may be used to prevent the computer chassis 202 and 204 from slipping apart during shipping.

FIG. 2D illustrates a perspective view of an alternative embodiment of the present invention in which multiple pairs of computer chassis are nested in a single chassis compartment. Shown in FIG. 2D are multiple pairs of computer chassis 202, 204, 206 and 208 nested in a single chassis compartment 212.

After nesting the computer chassis 202, 204, 206 and 208 into pairs or groups of pairs as described above, the nested pairs or groups of pairs may be arranged into the chassis compartments 212 on a pallet by well-known methods identical to those used in the arrangement of FIG. 1, except that each chassis compartment contains at least two computer chassis instead of only one. The weight capacity of each chassis compartment is advantageously increased by a factor that is equal to the number of computer chassis in each chassis compartment, while the rectangular volume of each chassis compartment is multiplied by a factor that is less than the number of computer chassis, depending on the degree of overlap achieved by the complementary shape selected for the identical computer chassis 202, 204, 206 and 208. For example, if two computers may be nested in a single chassis compartment that is 1.5 times the size of a chassis compartment for a single computer chassis, then the shipping density may be increased from (1/1=100 percent) to (2/1.5=4/3=133 percent), resulting in a savings of 33 percent in shipping costs.

The complementary shape of the computer chassis 202, 204, 206 and 208 may be selected according to well-known techniques so that the resulting shipping density of the pallet layout is substantially greater than that of the arrangement of FIG. 1. Forming the computer chassis 202, 204, 206 and 208 into a complementary shape so that they may be nested, stacked or interlocked in a single compartment of a pallet layout is an important feature of the present invention.

After the partially assembled computer chassis are unloaded at the manufacturing center, the final assembly may be completed. Each computer chassis may be inserted in a standard rectangular case according to well-known techniques to enhance the cosmetic appearance of the final product.

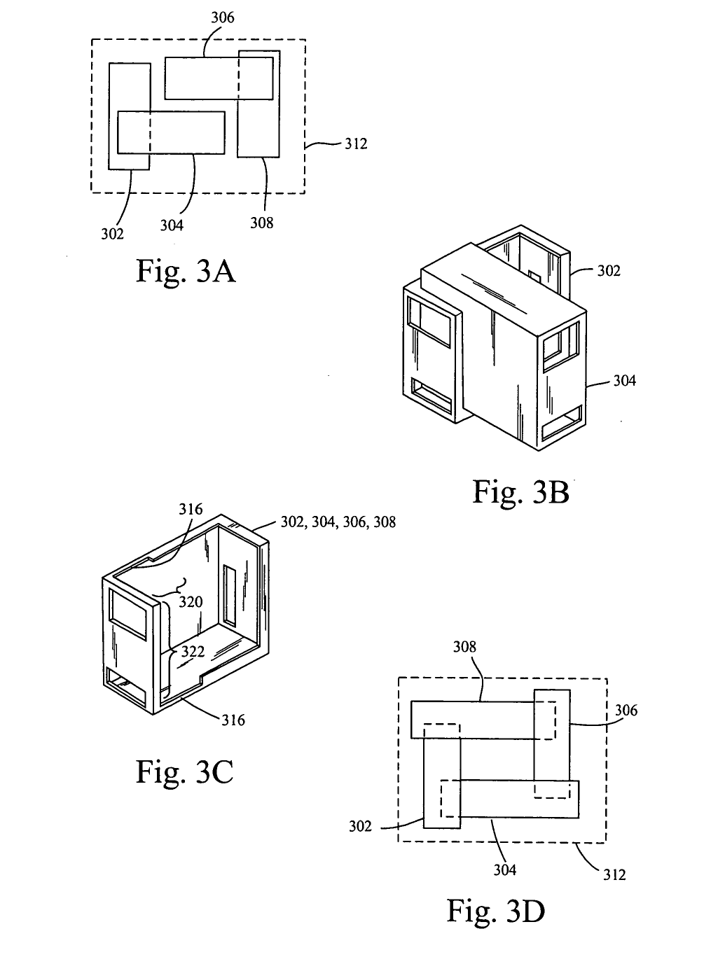

FIGS. 3A and 3B illustrate top and perspective views respectively of an embodiment of the present invention in which computer chassis are interlocked in pairs. Shown in FIGS. 3A and 3B are partially assembled identical computer chassis 302, 304, 306 and 308 and a chassis compartment 312.

In the arrangement of FIGS. 3A and 3B, the computer chassis 302, 304, 306 and 308 are formed into an identical complementary shape so that they may be joined perpendicularly to interlock.

FIG. 3C illustrates a single computer chassis having a complementary shape for the arrangement of FIGS. 3A and 3B. Shown in FIG. 3C is one of the identical computer chassis 302, 304, 306 and 308, recess features 316, an empty portion 320, and a non-empty portion 322. In the interlocked arrangement of FIGS. 3A and 3B, the complementary shape of the computer chassis 302, 304, 306 and 308 includes recess features 316 and the empty portion 320 that receives at least a portion of the non-empty portion 322 of another computer chassis 302, 304, 306 and 308. The actual shape of the non-empty portion 322 may be selected according to well-known techniques of mechanical design to accommodate a number of pre-assembled parts (not shown) that may be assembled on the computer chassis 302, 304, 306 and 308 before the partially assembled computer chassis 302, 304, 306 and 308 are shipped to a manufacturing center for final assembly.

FIG. 3D illustrates a top view of an alternative embodiment of the present invention in which multiple pairs of computer chassis may be interlocked in a single chassis compartment. Shown in FIG. 3D are a first pair of computer chassis 302 and 304, a second pair of computer chassis 306 and 308, and a chassis. compartment 312.

The multiple pairs of computer chassis 302, 304, 306 and 308 are joined perpendicularly in FIG. 3D so that they interlock inside the single chassis compartment 312.

After interlocking the computer chassis 302, 304, 306 and 308 into pairs or groups of pairs as described above, the interlocked pairs or groups of pairs may be arranged into chassis compartments on a pallet by well-known methods identical to those used in the arrangement of FIG. 1, except that each chassis compartment contains at least two computer chassis instead of only one. The weight capacity of each chassis compartment is advantageously increased by a factor that is equal to the number of computer chassis in each chassis compartment, while the rectangular volume of each chassis compartment is multiplied by a factor that is less than the number of computer chassis, depending on the degree of overlap achieved by the complementary shape selected for the identical computer chassis 302, 304, 306 and 308.

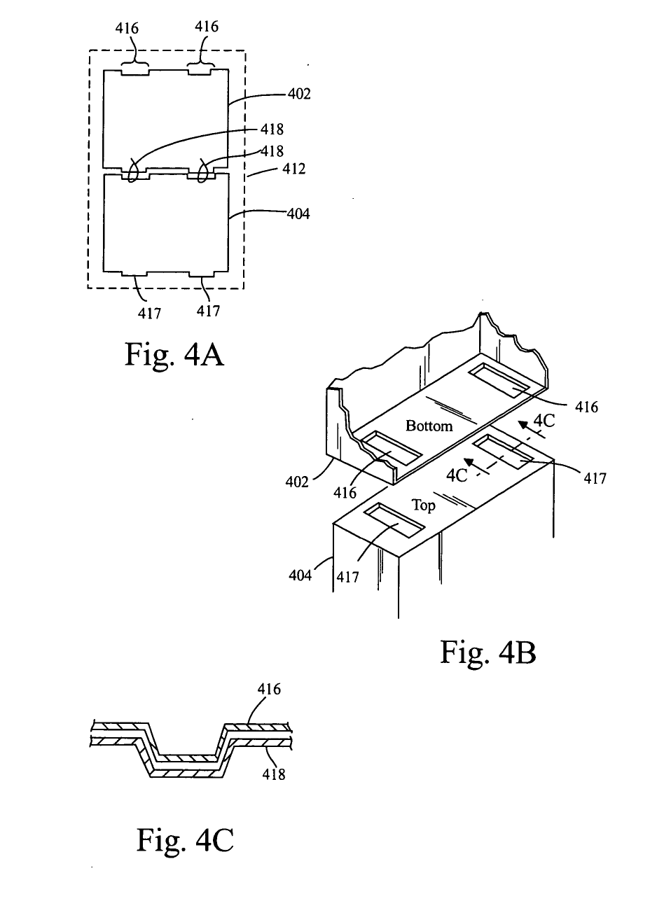

FIG. 4A illustrates a cross-sectional view of an alternative embodiment of the present invention in which a pair of computer chassis may be stacked in a single chassis compartment. Shown in FIG. 4A is a pair of partially assembled computer chassis 402 and 404, a chassis compartment 412, projections 416, channels 417, and fasteners 418.

In the arrangement of FIG. 4A, each of the computer chassis 402 and 404 has a complementary shape that includes the projections 416 that mate with the channels 417 when the computer chassis 402 and 404 are stacked vertically in pairs. Joining the computer chassis 402 and 404 by stacking them in pairs in the single chassis compartment 410 advantageously results in increased shipping density, while the projections 416 mated with the channels 417 prevent the computer chassis 402 and 404 from slipping apart. The computer chassis 402 and 404 may also be fastened together by the fasteners 418. Each of the fasteners 418 may be, for example, a tie wrap. The fasteners 418 may be used to prevent the computer chassis 402 and the computer chassis 404 from slipping apart during shipping.

FIG. 4B illustrates an exploded view of the computer chassis arrangement of FIG. A. Shown in FIG. 4B are the bottom of partially assembled computer chassis 402, the top of partially assembled computer chassis 404, projections 416, and channels 417.

The projections 416 on the bottom of partially assembled computer chassis 402 may be, for example, cushioned feet mounted on stamped metal features according to well-known techniques. The channels 417 on the top of partially assembled computer chassis 404 may be, for example, stamped metal features that may also serve to fasten a top panel of a cosmetic case after final assembly.

FIG. 4C illustrates a cross-sectional view of an interlocked projection and channel for the arrangement of FIGS. 4A and 4B. Shown in FIG. 4C are the one of the pair of projections 416 and channels 417 in FIG. 4B.

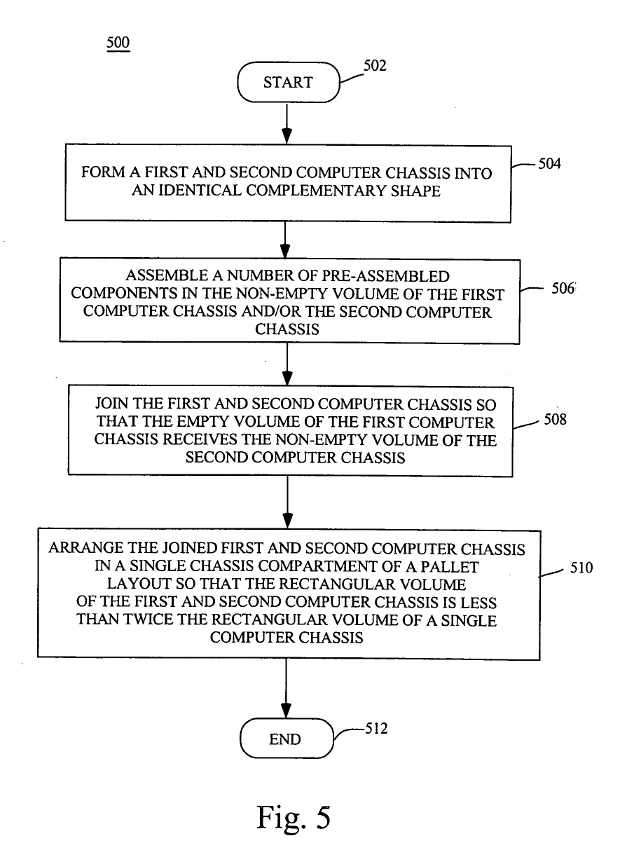

FIG. 5 illustrates a flow chart 500 of a method of increasing shipping density according to an embodiment of the present invention.

Step 502 is the entry point of the flow chart 500.

In step 504, a first and second computer chassis are formed into an identical complementary shape. The complementary shape includes an empty volume and a non-empty volume, for example, the empty volumes 214 and 314 illustrated respectively in FIGS. 2C and 3C.

In step 506, A number of pre-assembled components may be assembled in the non-empty volume of the first computer chassis and/or the second computer chassis. The pre-assembled components may include, for example, disk drives, and cable assemblies.

In step 508, the first and second computer chassis are joined so that the empty volume of the first computer chassis receives at least a portion of the non-empty volume of the second computer chassis. The first and second computer chassis may be joined, for example, by nesting, stacking, or interlocking the first computer chassis and the second computer chassis in a single compartment of a pallet layout to increase the shipping density of the pallet layout. The first computer chassis may also be fastened to the second computer chassis where the computer chassis overlap in the empty volume, for example, by a tie wrap. In alternative embodiments, multiple pairs of joined computer chassis may be arranged in a single compartment of a pallet layout to increase the shipping density of a container.

In step 510, the joined first and second computer chassis are arranged in a single chassis compartment of a pallet layout so that the rectangular volume of the first and second computer chassis is less than twice the rectangular volume of a single computer chassis.

Step 512 is the exit point of the flow chart 500.

Although the method of the present invention illustrated by the flowchart description above is described and shown with reference to specific steps performed in a specific order, these steps may be combined, sub-divided, or reordered without departing from the scope of the claims. Unless specifically indicated herein, the order and grouping of steps is not a limitation of the present invention.

While the invention herein disclosed has been described by means of specific embodiments and applications thereof, numerous modifications and variations may be made thereto by those skilled in the art without departing from the scope of the invention set forth in the following claims.

1. A method comprising steps of:
(a) forming a first and second computer chassis into a complementary shape wherein the complementary shape includes an empty volume and a non-empty volume; and
(b) joining the first and second computer chassis so that the empty volume of the first computer chassis receives at least a portion of the non-empty volume of the second computer chassis.

2. The method of claim 1 wherein step (b) comprises nesting, stacking, or interlocking the first computer chassis and the second computer chassis in a single compartment of a pallet layout.

3. The method of claim 1 further comprising a step of arranging the joined first and second computer chassis in a single compartment of a pallet layout to increase shipping density of a pallet layout.

4. The method of claim 1 further comprising a step of assembling a number of pre-assembled components in the non-empty volume of at least one of the first computer chassis and the second computer chassis.

5. The method of claim 1 further comprising a step of fastening the first computer chassis to the second computer chassis.

6. The method of claim 1 further comprising a step of arranging multiple pairs of the joined first and second computer chassis in a single compartment of a pallet layout to increase shipping density of the pallet layout.

7. The method of claim 1 wherein step (a) comprises forming the first and second computer chassis into an identical complementary shape.

8. An apparatus comprising:
a first computer chassis; and
a second computer chassis joined to the first computer chassis wherein the first computer chassis and the second computer chassis are formed into a complementary shape that includes an empty volume and a non-empty volume wherein the empty volume of the first computer chassis receives at least a portion of the non-empty volume of the second computer chassis.

9. The apparatus of claim 8 wherein the first computer chassis and the second computer chassis are joined by nesting, stacking, or interlocking the first computer chassis and the second computer chassis in a single compartment of a pallet layout.

10. The apparatus of claim 8 wherein the joined first and second computer chassis are arranged in a single compartment of a pallet layout to increase shipping density of a pallet layout.

11. The apparatus of claim 8 further comprising a number of pre-assembled components assembled in the non-empty volume of at least one of the first computer chassis and the second computer chassis.

12. The apparatus of claim 8 further comprising a fastener for fastening the first computer chassis to the second computer chassis.

13. The apparatus of claim 7 further comprising multiple pairs of the joined first and second computer chassis arranged in a single compartment of a pallet layout to increase shipping density of the pallet layout.

14. The apparatus of claim 7 wherein the first computer chassis and the second computer chassis are formed into an identical complementary shape.

15. A method comprising steps of:
(a) forming a first and second computer chassis into a complementary shape wherein the complementary shape includes an empty volume and a non-empty volume;
(b) joining the first and second computer chassis so that the empty volume of the first computer chassis receives at least a portion of the non-empty volume of the second computer chassis; and
(c) arranging the first and second computer chassis in a single chassis compartment of a pallet layout wherein a rectangular volume of the first and second computer chassis is less than twice a rectangular volume of a single computer chassis.
